(19) United States
(12) Patent Application Publication
(10) Pub. No.: US 2004/0046688 A1
(43) Pub. Date: Mar. 11, 2004

(54) Mobile surveillance vehicle system

(76) Inventors: Mark W. Bigge, Bath, ME (US); Christopher B. Adams, Los Angeles, CA (US)

Correspondence Address: Sanford Astor, Suite 200, 10507 West Pico Blvd., Los Angeles, CA, 90064, US

(21) Appl. No.: 10/236,154

(22) Filed: Sep. 6, 2002

(51) Int. Cl. G01S 13/86

(52) U.S. Cl. 342/52; 342/53; 342/28

(57) ABSTRACT

A mobile surveillance vehicle security system, comprising one or more low profile vehicles equipped with a combination of thermal and radar equipment to provide surveillance of large areas using few assets, extended line-of-sight surveillance, integration with other sensor systems, information sharing, and system survivability of loss of sensors and vehicles.

This invention is described in our Disclosure Document No. 500900, filed Oct. 5, 2001.

### BACKGROUND OF THE INVENTION

Presently, the U.S. Armed Forces utilize a few types of mobile surveillance vehicles. These are the Bradley fighting vehicle conversion, an armored six wheeled troop transport with extremely obvious exterior assets, the Magic Warrior/Nightstalker, a Hum-Vee containing some thermal energy detection equipment and some radar and the LRAS-3, a Hum-Vee that also incorporates a single thermal detector.

The Bradley fighting vehicle conversion results in an armored personnel carrier (APC) loaded with a suite of electronics. It is neither fast nor stealthy.

The Magic Warrior Nightstalker and LRAS-3 are both based on Hum-Vee platforms. While this is a definite improvement over the Bradley, it still is extensively visibly different than the other vehicles in any area of operations. This makes it an immediate target to an enemy force.

All of the current systems have two weaknesses. The first is that they are all easily differentiated from other vehicles. This increases their chances of being targeted and destroyed. As a result, the information being collected will be lost when the vehicle is destroyed by enemy fire. The second weakness is that all of these systems place an extraordinary amount of value on one vehicle. By placing extremely expensive sensor suites in one vehicle and not networking a series of sensor distributed vehicles, these systems make themselves extremely vulnerable to a complete breakdown of information gathering capability.

### SUMMARY OF THE INVENTION

Applicants' invention comprises a low profile mobile vehicle security system which provides security for areas of intelligence gathering teams, mobile base security, targeting of enemy forces, command and control information, field command post capability, and security escort. It offers a low profile, multi-purpose ground surveillance platform that is able to link up with additional mobile units as needed and available.

Applicants' invention provides a solution to both problems common to all current systems. The division of sensor systems across many vehicles and the use of less conspicuous sensors make the vehicles of less obvious importance to the enemy. As a result, they will be targeted less frequently by enemy forces. The sharing of many sensors across many vehicles also makes the loss of one vehicle of much less impact to the operation as a whole. The sharing of intelligence in real time provides for a system which will only lose some percentage of its operability when one vehicle is lost. This resolves the problem of the current systems going completely off-line when the one-and-only vehicle is destroyed.

### OBJECTS AND ADVANTAGES OF THE INVENTION

Accordingly, several objects and advantages of the invention are as follows:

It is an object of the present invention to provide a mobile system to acquire intelligence over a vast area in little time.

It is an object of the invention to provide a mobile system which can communicate with command and other mobile units in real-time seamlessly.

It is an object of the invention that the surveillance and communications equipment not be obvious to enemy forces.

It is an advantage of the invention that it is not easily discernible from other standard military vehicles and will not cause enemy forces to single out the vehicle for attack.

It is an advantage of the invention that when one vehicle is destroyed, the most up-to-date information from the vehicle is already available to other vehicles and to command staff.

It is an advantage of the invention that when one vehicle is destroyed, there are other vehicles in the area of operations with distributed sensors to insure that surveillance information is not interrupted.

These, as well as other objects and advantages of the invention will become obvious from the following description:

### BRIEF DESCRIPTION OF THE DRAWINGS

FIG. 1 is a side elevation view of the mobile vehicle with a thermal sensor and ground radar with the mast not extended;

FIG. 2 is a side elevation view of the mobile vehicle with a thermal sensor and ground radar with the mast extended;

FIG. 3 is a schematic of the thermal sensor and ground radar portion of the invention, together with a TOW 2 missile launcher mounted on the vehicle;

### DETAILED DESCRIPTION OF THE INVENTION

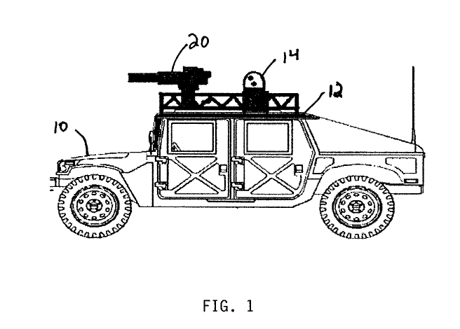

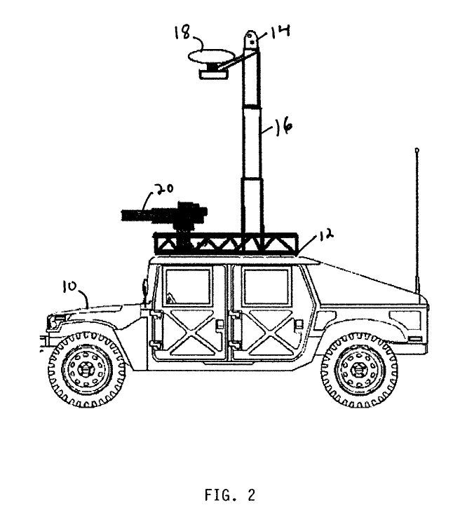

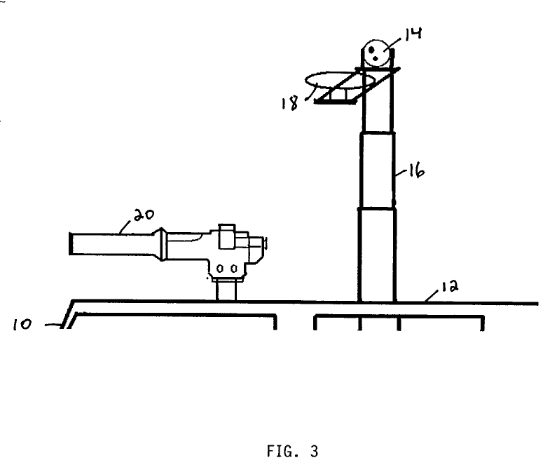

Referring now to FIG. 1-FIG. 3, there is shown the mobile vehicle system of this invention. The system comprises the vehicle itself 10 which is a Hum-Vee, as shown, but could be another vehicle if it fit the performance needs of the system. The Hum-Vee, with its wide wheelbase and low profile, has proven to be a very suitable vehicle for this system.

The vehicle platform 12 has added to it a light weight, all weather, thermal imager 14 such as the Wescam Model 12DS200 mounted on a telescoping mast 16, such as the Willburt #6-30. Mast 16 telescopes to approximately 30 feet in length. The thermal imager 14 provides continuous long range field of vision with the ability to track direction and distance.

A pulse emission ground doppler surveillance radar system 18, such as manufactured by Syracuse Research Corp. Model AN/PPS5-D, can cue-up the thermal imager 14 directly from the radar 18 to the imager l4 for fast and accurate target recognition. This allows the systems to work in conjunction. The radar system 18 provides general target acquisition, while the thermal imager system 14 provides visual verification and recognition. Furthermore, should efforts be made by an opposing force to defeat one of the two types of sensors, the alternate will detect the target.

The benefits of the telescoping mast 16 include a low profile when not in use, an increased area of surveillance in use, a greater potential for direct line of sight to the target, and the ability to obscure the vehicle in a geographic depression while maintaining surveillance from a high point. The elevated thermal imager 14 and radar system 18 provide the ability to scan for targets that would normally go undetected with standard light enhancement or night vision gear at ground level.

A TOW2 missile launcher 20 may be mounted on the vehicle platform 12, for protection and offensive action.

Air assets and satellite information may be accessed to provide area surveillance that can be overlaid by localized detailed surveillance with this system.

The system may comprise only one vehicle or provide even better area surveillance coverage by providing a plurality of vehicles with thermal imaging and radar capability to spread out and cover a wide area and to share information. If one vehicle is destroyed the others have already accessed the information and transmitted it to command. The combination of all sensors combine to verify all information gathered and to exceed the amount of data that would be gathered by any one sensor on its own.

A receiver/transmitter in the vehicle provides real-time communication to other units of the system of all information gathered and then relays the data back to command. For example, the Harris Corp. Model AN/PRC-117 & AN/PRC-150-w-150 amp. transmitters provide secure high frequency transmission beyond line-of-sight, with encryption capability. The AN/PRC-117 provides a back-up secure satellite option in the event of communications breakdowns to provide information back to command.

The system of this invention allows for intelligence preparation of the battlefield, critical for the support of force protection. The system may run while underway with the mast extended as much as half way, providing unmatched mobile security. By deploying any number of these vehicles, in varying formation, security perimeters are created. When the mast is extended and communications are established, and the radar and thermal imaging units are lifted and locked into working position, optimized surveillance can begin.

Typically, three crewmen are used to operate a vehicle. Setup time is under seven minutes for the extendable pole thermal/ground radar units.

The mobile system of this invention can be utilized for drug interdiction, terrorist detection, mine sweep detail, force protection, border surveillance, VIP security, airfield security, forward observation or as a scout vehicle for a fast reaction force.

Having thus described the invention, we claim:

1: A mobile low profile surveillance vehicle comprising a thermal imager and a ground radar system both mounted on a telescoping mast.

2: The vehicle of claim 1 where in the thermal imager is a light weight, all weather thermal imager.

3: The vehicle of claim 1, where the ground radar is a pulse emission ground Doppler surveillance radar system.

4: The vehicle of claim 1 in which the vehicle is a Hum-Vee.

5: The vehicle of claim 1 further comprising a TOW2 missile launcher.

6: The vehicle of claim 1 further comprising a receiver/transmitter to provide real-time communication.

7: A mobile surveillance perimeter protection system comprising a plurality of mobile, low profile, surveillance vehicles, each vehicle comprising a thermal imager and a ground radar system both mounted on a telescoping mast.

8: The system of claim 7 wherein the thermal imagers are light weight, all weather thermal imagers.

9: The system of claim 7, wherein the ground radar systems are pulse emission ground doppler surveillance radar systems.

10: The system of claim 7 in which the vehicles are Hum-Vees.

11: The system of claim 7 in which each of the vehicles further comprise a TOW2 missile launcher.

12: The system of claim 7 in which each vehicle is further equipped with a receiver/transmitter to provide real-time communication.
